(19) United States
(12) Patent Application Publication
(10) Pub. No.: US 2026/0037510 A1
(43) Pub. Date: Feb. 5, 2026

(54) DYNAMIC ANALYTICAL MODEL OPTIMIZATIONS

(71) Applicant: SAP SE, Walldorf (DE)

(72) Inventors: Devicharan Vinnakota, Bangalore (IN); Priyanka Kommanapalli, Bangalore (IN); Jaya Gupta, Bangalore (IN)

(21) Appl. No.: 18/887,463

(22) Filed: Sep. 17, 2024

(30) Foreign Application Priority Data
Aug. 3, 2024 (IN) 202411058818

(51) Int. Cl. G06F 16/2453

(52) U.S. Cl. CPC G06F 16/24542; G06F 16/24537

(57) ABSTRACT

In an example embodiment, a mechanism is provided to dynamically determine optimizations of data model execution at runtime at an engine-by-engine level, meaning that one optimization may be applied to one engine and not others. This mechanism is enabled by also providing a method by which model optimizations are stored and retrieved using a hash representation of each model, allowing past optimizations to be reused. Thus, the next time a similar model is built, optimizations of an earlier model can be reused. A definition store is also used as a basis to create new optimizations dynamically.

### CLAIM OF PRIORITY

The present patent application claims the priority benefit of the filing date of Indian Provisional Application No. 202411058818 filed Aug. 3, 2024, the entire content of which is incorporated herein by reference.

### TECHNICAL FIELD

This document generally relates to computer software analytics software. More specifically, this document relates to dynamic analytical model optimizations.

### BACKGROUND

Analytics software allows individuals and entities such as businesses to obtain various analytics content, such as summaries, predictions, models, stories, visualizations, and value-driver trees (VDTs), typically regarding the functioning of an organization. An example of analytics software is the SAP Analytics Cloud™ (SAC), from SAP SE of Walldorf, Germany, which combines business intelligence, planning, and predictive capabilities.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating a system for automatically performing database optimizations, in accordance with an example embodiment.

FIG. 2 is a block diagram illustrating an example of a database execution engine, in accordance with some example implementations.

FIG. 3 is a flow diagram illustrating a method for handling a query in a database, in accordance with an example embodiment.

FIG. 4 is a block diagram illustrating an architecture of software, which can be installed on any one or more of the devices described above.

FIG. 5 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth to provide an understanding of various example embodiments of the present subject matter. It will be evident, however, to those skilled in the art, that various example embodiments of the present subject matter may be practiced without these specific details.

In any business intelligence/analytics platform, the analytics content plays a central role in discovering the unseen patterns in an organization. Hence, sharing of the analytics content across users is very helpful for better collaboration. Additionally, standard content templates can be reused by different users, who may then have those templates applied to their own data. The infrastructure for sharing analytics content is an Analytical Content Network (ACN). Shared SAC content is called a “package.”

An enterprise can use multiple systems for storing and processing data. For example, an enterprise can use a system that stores data in a database system and provides metadata that defines how the data is stored and how the data is accessed. Analytics systems have been introduced that provide advanced analytics capabilities and improved data processing performance as compared to that provided by other systems, such as a system within which the enterprise stores and maintains its data. Such analytics systems can include cloud-based analytics systems that include an analytics engine that is executed directly within the underlying database system. Such an analytics engine can be referred to as a database (DB) analytics engine (DB-based analytics engine).

By way of non-limiting example, an example cloud-based analytics system includes SAP Analytics Cloud (SAC) provided by SAP SE of Walldorf, Germany. SAC can be described as an all-in-one platform for business intelligence, planning, and predictive analytics to support enterprise operations. In some examples, SAP SAC uses multi-dimensional services (MDS), which provide a DB-based analytics engine. SAP SAC provides requests to the MDS in a particular protocol (e.g., information access (InA) protocol), which enables more complex data analytics requests to be formulated and executed (e.g., as compared to data analytics requests submitted through the DW).

A user may operate a graphical user interface of an Analytics Cloud to create one or more models. A model is a representation of the data of an organization or segment. One type of model a user can create is an analytic model, which is used to analyze data, such as by looking for trends and anomalies. Data modeling includes data wrangling, or cleaning, the dataset, defining measures and dimensions, and enhancing the data by establishing hierarchies, setting units and currencies, and adding formulas, for instance.

A data model behind the scenes contains joined tables (a hierarchy of tables, typically). At runtime, the model executes, which causes data specified by the model to be retrieved from various data sources and stored in a database. In an example embodiment, this is an in-memory database. One example of an in-memory database is HANA™, from SAP SE of Walldorf, Germany. An in-memory database (also known as an in-memory database management system) is a type of database management system that primarily relies on main memory for computer data storage. It is contrasted with database management systems that employ a disk storage mechanism. In-memory databases are traditionally faster than disk storage databases because disk access is slower than memory access.

An Analytics Cloud may contain a number of different engines to perform various tasks during the runtime execution of the model. Examples include an analytical engine, a calculation (calc) engine, a SQL engine, and an MDS engine. One or more optimizations can be applied to the executions performed by such engines. In some environments, these optimizations (also called “hints”) are specified at the server-level, meaning that they are applied to all executions of a model, regardless of component. Such environments, however, are prone to performance issues due to the non-granular nature of the optimizations and due to the fact that these optimizations are static in nature.

In an example embodiment, a mechanism is provided to dynamically determine optimizations of data model execution at runtime at an engine-by-engine level, meaning that one optimization may be applied to one engine and not others. This mechanism is enabled by also providing a method by which model optimizations are stored and retrieved using a hash representation of each model, allowing past optimizations to be reused. Thus, the next time a similar model is built, optimizations of an earlier model can be reused. A definition store is also used as a basis to create new optimizations dynamically.

Thus, for example, suppose one has enabled the cube cache optimization on HANA system-wide, but the view created for customer use case has a table which has huge data, and there is already high Central Processing Unit (CPU) usage on the HANA side which is running out of memory, so we would need to set the enable_cube_cache hint to false (caching is now disabled for that particular model) only for that view to preserve memory.

Analytical queries often lend themselves to parallel processing, where multiple CPU cores work in parallel to process data. Optimizations can encourage the database engine to parallelize certain parts of the query, taking advantage of the available hardware resources. When one knows queries with the same batch can be run in parallel to improve the speed of execution, then one can configure the optimization parallel_query_execution to true (which enables parallel query processing of batch requests) at the query level.

If one wants to save CPU and compilation time and enable the gathering of statistics (username, execution count, average execution time, and so on) for each plan, then in an example embodiment, a SQL Plan Cache can be established, which saves compiled plans so that the same query does not need to be compiled every time. These optimizations, however, are largely customer-specific, and may differ across customer landscapes based on their respective data sets.

The Analytical Cloud, however, can be completely unaware of these customer-specific needs and optimizations. Thus, the dynamic generation of optimizations can remedy this.

At runtime, whenever a call attempts to fetch data from a database, a hash of the data model can be passed to a dynamic optimization generation component, which acts to dynamically generate one or more optimizations for the data model. How this dynamic optimization generation component is implemented can vary. In an example embodiment, the dynamic optimization generation component can see if a hash for the data model already exists. If so, then one or more optimizations previously used for the data model may be reused. If not, then the dynamic optimization generation component may make a call to the customer to provide engine-level optimizations to execute. The customer may then respond with one or more such optimizations, such as with a document containing one or more optimization sections. Each such section may correspond to a different engine in the Analytics Cloud. For example, the sections may include a SQL section, an MDS section, and a calculations (calcs) section.

The MDS and calcs section optimizations get applied to a runtime Information Access (IA) query. MDS optimizations are used within the MDS processing and influence certain aspects of that processing. Calc optimizations are directly passed to the calculation engine on an MDS-generated calc scenario. SQL optimizations get applied to the end of a SQL query. These optimizations may be used whenever the MDS engine sends internal SQL queries, such as for reading metadata (BIMC views) or reading attributes. An Analytics Catalog may contain tables and views with the prefix BIMC located in a schema and contains metadata used by analytic clients.

The optimization(s) may be stitched with the IA request. In some example embodiments, the engine-level optimizations may coexist with broader server-level optimizations. In some instances, these optimizations can cause repetition of optimizations, which can cause performance degradation. Thus, in an example embodiment, a determination is made dynamically at runtime whether optimizations being stitched are also part of server-level optimizations. If there are such duplications, then the engine-level optimization(s) take precedence and the server level optimization(s) are ignored or deleted.

In an example embodiment, the dynamic optimization generation component may do more than simply make calls to the customer(s) asking for engine-level optimizations but may automatically generate such optimizations on its own (or at least with customer approval). In an example embodiment, a set of rules is stored in a rule repository. These rules indicate ways to analyze contextual information to select one or more engine-level optimizations from an optimization dictionary. This contextual information may include, for example, one or more hashes of data models similar to the data model to which the optimizations are to be applied, customer information, and tenant information. Customer information may include items such as customer identification, industry, processing requirements, available processing (or other resources), resource utilization, etc.

In another example embodiment, the dynamic optimization generation component may include a machine learning model trained by a machine learning algorithm to generate one or more engine-level optimizations for a data model.

Specifically, the machine learning model may be trained by any algorithm from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbors, decision trees, and hidden Markov models.

In an example embodiment, a machine learning algorithm used to train a machine learning model may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

In some example embodiments, the training of these machine learning models may take place as a dedicated training phase. In other example embodiments, the machine learning models may be retrained dynamically at runtime based on, for example, developer or user feedback.

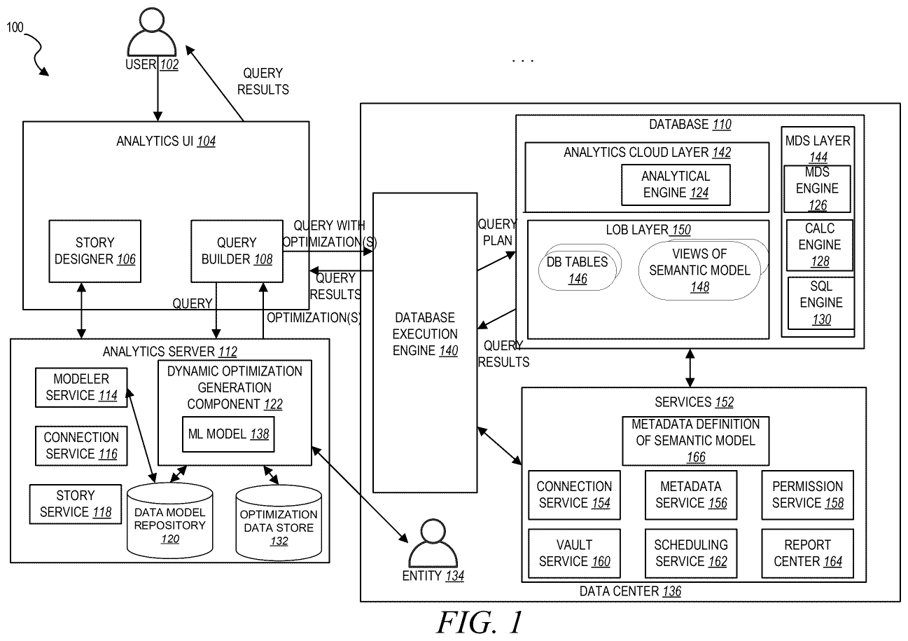

FIG. 1 is a block diagram illustrating a system 100 for automatically performing database optimizations, in accordance with an example embodiment. Here, user 102 interacts with an analytics user interface (UI) 104 in a manner to generate a database query. This interaction may occur in a number of different ways, through various textual and graphical user interface input. In some example embodiments, this may occur with the user creating what is called a “story.” In this context, the term “story” refers to presentation-style document that uses charts, visualizations, text, images, pictograms, etc. to describe data. These stories can also be referred to as reports or dashboards. A story designer 106 may be part of the analytics UI 104 to accomplish this goal.

It should be noted that there may be other ways for the user 102 to interact with the analytics UI 104 in a manner that generates a query, and thus nothing in this disclosure shall be interpreting as requiring the use of a story designer 106 as part of the query creation process.

No matter how the query is constructed, the actual building of the query may be performed by a query builder 108. Generally, the query will be requesting some information (with the information being potentially stored in the database 110, although the information is not always stored in the database 110 and thus sometimes the query results in no or insufficient information retrieved from the database 110.

The query is passed from the query builder 108 to an analytics server 112. The analytics server 112 acts as a counterpart to the analytics UI 104 to aid on the generation of queries to the database 110. Here, the analytics server 112 includes a number of different services, including modeler service 114, connection service 116, and story service 118. The modeler service 114 acts to generate and manage one or more data models, which are stored in a data model repository 120. As mentioned earlier, a data model in this context is a representation of the data of an organization or segment, and specifically a model that is used to analyze data, such as by looking for trends and anomalies.

The connection service 116 allows for the establishment of connectivity between cloud applications and on-premises systems running in isolated networks. The story service 118 manages the previously described stories created by users, such as user 102.

In an example embodiment, a dynamic optimization generation component 122 is provided. The goal of the dynamic optimization generation component 122 is to dynamically generate one or more optimizations for the query, and specifically to generate one or more engine-level optimizations. Specifically, as will be seen later in the description of FIG. 1, the database 110 executes the query using one or more engines, specifically here an analytical engine 124, an MDS engine 126, a calc engine 128, and an SQL engine 130.

The dynamic optimization generation component 122 identifies an appropriate data model in the data model repository 120 to apply to the query. This identification may occur in a number of different ways, including it being deduced by the dynamic optimization generation component 122 and the appropriate data model being identified with the query from the analytics UI 104 itself.

The dynamic optimization generation component 122 then acts to automatically generate one or more engine-level optimizations for the appropriate data model. How this dynamic optimization generation component is implemented can vary. In an example embodiment, the dynamic optimization generation component can see if a hash for the data model already exists in an optimization data store 132. If so, then one or more optimizations previously used for the data model may be reused. If not, then the dynamic optimization generation component 122 may make a call to an entity 134 associated with the data center 136 to provide engine-level optimizations to execute. The entity 134 may then respond with one or more such optimizations, such as with a document containing one or more optimization sections. Each such section may correspond to a different engine in the Analytics Cloud. For example, the sections may include a SQL section, an MDS section, and a calcs section.

In another example embodiment, the dynamic optimization generation component 122 uses a machine learning model 138 to automatically generate the engine optimization(s).

The optimization(s) may be returned to the query builder 108 where it/they can be stitched with the query. This query and optimization combination may then be sent to a database execution engine 140 for processing. This stitching may include combing the query and the optimization(s) into an Information Access (IA) request. The database execution engine 140 generates a query plan for the query (with the optimizations). This query plan is then sent to the database 110 for execution. Specifically, an analytics cloud layer 142 in the database 110 contains the analytical engine 124, which executes any analytical engine-based optimizations. An MDS layer 144 contains the MDS engine 126, the calc engine 128, and the SQL engine 130, which likewise will execute any relevant engine-based optimizations.

The execution of the query plan can also include accessing one or more database tables 146 and views of the semantic model 148 in the database 110, which may be contained in a line-of-business (LOB) layer 150.

The creation of the query plan and the execution of the query plan can also include the use of one or more services 152, such as a connection service 154, a metadata service 156, a permission service 158, a vault service 160, a scheduling service 162, a report center 164, and a metadata definition of the semantic model 166.

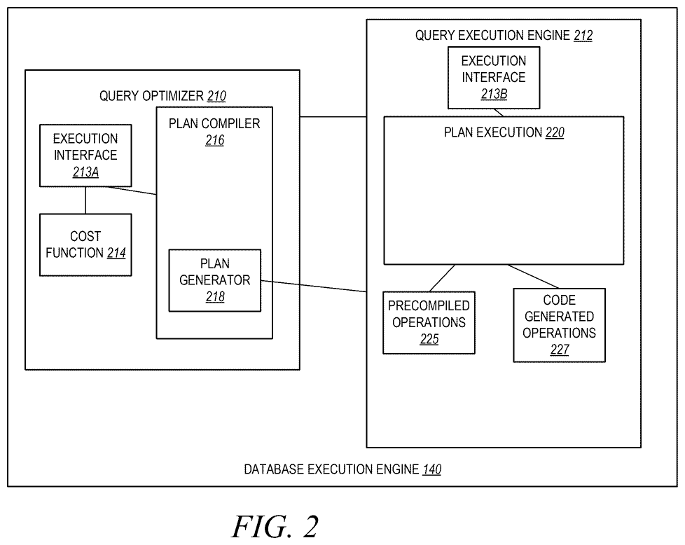

FIG. 2 is a block diagram illustrating an example of a database execution engine 140 of FIG. 1, in accordance with some example implementations.

The database execution engine 140 may include a query optimizer 210, such as a SQL optimizer and/or another type of optimizer, to receive at least one query from a user equipment and generate a query plan (which may be optimized) for execution by the query execution engine 212. The query optimizer 210 may receive a request, such as a query, and then form or propose an optimized query plan. The query plan (which may be optimized) may be represented as so-called “query algebra” or “relational algebra.”

For example, a database command “SELECT id, x, n FROM T1 JOIN T2 ON T1.x=T2.x ORDER BY T2.n LIMIT K” may be received by the database execution engine 250 comprising the query optimizer 210. There may be several ways of implementing execution of this query. As such, the query plan may offer hints or propose an optimum query plan with respect to the execution time of the overall query. To optimize a query, the query optimizer 210 may obtain one or more costs for the different ways the execution of the query plan can be performed. The costs may be obtained via the execution interface 213A from a cost function 214, which responds to the query optimizer 210 with the cost(s) for a given query plan (or portion thereof), and these costs may be in terms of execution time at the database.

The query optimizer 210 may form an optimum query plan, which may represent a query algebra, as noted above. To compile a query plan, the query optimizer 210 may provide the query plan to the query plan compiler 216 to enable compilation of some, if not all, of the query plan. The query plan compiler 216 may compile the optimized query algebra into operations, such as program code and/or any other type of command, operation, object, or instruction. This code may include pre-compiled code (which can be pre-compiled and stored, and then selected for certain operations in the query plan) and/or just-in-time code generated specifically for execution of the query plan. For example, a plan compiler may select pre-compiled code for a given operation as part of the optimization of the query plan, while for another operation in the query plan, the plan compiler may allow a compiler to generate the code. The pre-compiled and generated code represents code for executing the query plan, and this code may be provided to the plan generator 218, which interfaces with the plan execution engine 220.

In some implementations, the query optimizer 210 may optimize the query plan by compiling and generating code. Moreover, the query optimizer 210 may optimize the query plan to enable pipelining during execution.

In some implementations, the query optimizer 210 may be configured to select other execution engines. For example, the query optimizer 210 may select, an execution engine configured specifically to support a row-store database or an ABAP type database, or the query optimizer 210 may select an execution engine configured specifically to support a column-store type database. In this way, the query optimizer 210 may select whether to use the universal database execution engine 250 or legacy (e.g., database-specific) execution engines.

The query execution engine 212 may receive from the plan generator 218, compiled code to enable execution of the optimized query plan, although the query execution engine may also receive code or other commands directly from a higher-level application or other device.

The query execution engine 212 may then forward, via an execution interface 213B, the code to a plan execution engine 220. The plan execution engine may then prepare the plan for execution, and this query plan may include pre-compiled code 225 and/or generated code 227.

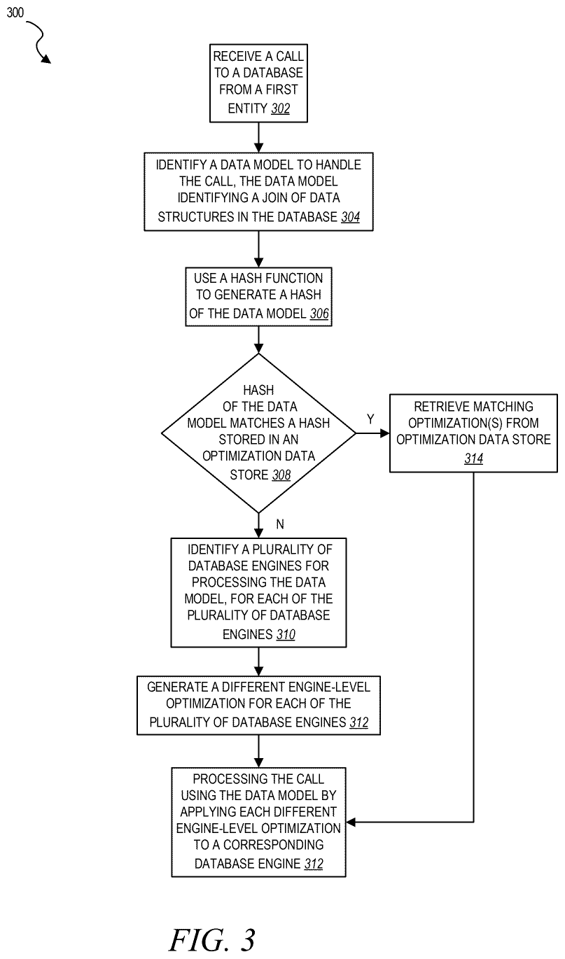

FIG. 3 is a flow diagram illustrating a method 300 for handling a query in a database, in accordance with an example embodiment. At operation 302, a call to a database is received from a first entity. At operation 304, a data model to handle the call is received. The data model identifies a join of data structures in the database]. At operation 306, a hash function is used to generate a hash of the data model.

At operation 308, it is determined whether the hash of the data model matches a hash stored in an optimization data store. If not, then at operation 310, a plurality of database engines for processing the data model are identified. Then at operation 312 a different engine-level optimization is generated for each of the plurality of different database engines. Then, at operation 314, the call is processed using the data model by applying each different engine-level optimization to a corresponding database engine.

If at operation 308 it was determined that the hash of the data model does match a hash stored in an optimization data store, then at operation 314 the corresponding matching optimization(s) is/are retrieved from the optimization data store. Then at operation 312, the call is processed using the data model by applying each different engine-level optimization to a corresponding database engine.

In view of the disclosure above, various examples are set forth below. It should be noted that one or more features of an example, taken in isolation or combination, should be considered within the disclosure of this application.

Example 1 is a system comprising: at least one hardware processor; and a computer-readable medium storing instructions that, when executed by the at least one hardware processor, cause the at least one hardware processor to perform operations comprising: receiving a call to a database from a first entity; identifying a data model to handle the call, the data model identifying the joining of data structures in the database; using a hash function to generate a hash of the data model; determining whether the hash of the data model matches a hash stored in an optimization data store; in response to a determination that the hash of the data model does not match a hash stored in the optimization data store: identifying a plurality of database engines for processing the data model; for each of the plurality of database engines, generating a different engine-level optimization based on a predicted volume of data to be used to process the call using the data model and based on type of the first entity, each different engine-level optimization indicating a change in process flow for a corresponding database engine; and processing the call using the data model by applying each different engine-level optimization to a corresponding database engine.

In Example 2, the subject matter of Example 1 comprises, wherein the generating comprises: sending a message to the first entity requesting a separate engine-level database optimization for each of the plurality of database engines requesting, the message comprising the hash.

In Example 3, the subject matter of Examples 1-2 comprises, wherein processing the call comprises stitching each different engine-level database optimization to an information access query to be sent to the database.

In Example 4, the subject matter of Example 3 comprises, wherein the operations further comprise: determining whether a server level database optimization exists for the data model and prioritizing each different engine-level optimization over the server level database optimization if there are any conflicts.

In Example 5, the subject matter of Examples 1-4 comprises, wherein the database is an in-memory database.

In Example 6, the subject matter of Examples 1-5 comprises, wherein the generating comprises: passing the hash and an indication of the first entity to a machine learning model trained by a machine learning algorithm to generate different engine-level optimization based on a predicted volume of data to be used to process the call using the data model and based on type of the first entity.

In Example 7, the subject matter of Examples 1-6 comprises, wherein in response to a determination that the hash of the data model matches a hash stored in the optimization data store: retrieving one or more previously used engine-level database optimizations corresponding to the hash stored in the optimization data store and processing the call using the data model by applying each previously used different engine-level optimizations to a corresponding database engine.

Example 8 is a method comprising: receiving a call to a database from a first entity; identifying a data model to handle the call, the data model identifying the joining of data structures in the database; using a hash function to generate a hash of the data model; determining whether the hash of the data model matches a hash stored in an optimization data store; in response to a determination that the hash of the data model does not match a hash stored in the optimization data store: identifying a plurality of database engines for processing the data model; for each of the plurality of database engines, generating a different engine-level optimization based on a predicted volume of data to be used to process the call using the data model and based on type of the first entity, each different engine-level optimization indicating a change in process flow for a corresponding database engine; and processing the call using the data model by applying each different engine-level optimization to a corresponding database engine.

In Example 9, the subject matter of Example 8 comprises, wherein the generating comprises: sending a message to the first entity requesting a separate engine-level database optimization for each of the plurality of database engines requesting, the message comprising the hash.

In Example 10, the subject matter of Examples 8-9 comprises, wherein processing the call comprises stitching each different engine-level database optimization to an information access query to be sent to the database.

In Example 11, the subject matter of Example 10 comprises, determining whether a server level database optimization exists for the data model and prioritizing each different engine-level optimization over the server level database optimization if there are any conflicts.

In Example 12, the subject matter of Examples 8-11 comprises, wherein the database is an in-memory database.

In Example 13, the subject matter of Examples 8-12 comprises, wherein the generating comprises: passing the hash and an indication of the first entity to a machine learning model trained by a machine learning algorithm to generate different engine-level optimization based on a predicted volume of data to be used to process the call using the data model and based on type of the first entity.

In Example 14, the subject matter of Examples 8-13 comprises, wherein in response to a determination that the hash of the data model matches a hash stored in the optimization data store: retrieving one or more previously used engine-level database optimizations corresponding to the hash stored in the optimization data store; and processing the call using the data model by applying each previously used different engine-level optimization to a corresponding database engine.

Example 15 is a non-transitory machine-readable medium storing instructions which, when executed by one or more processors, cause the one or more processors to perform operations comprising: accessing historical time series data regarding workload of a first computer service; receiving a call to a database from a first entity; identifying a data model to handle the call, the data model identifying a join of data structures in the database; using a hash function to generate a hash of the data model; determining whether the hash of the data model matches a hash stored in an optimization data store; in response to a determination that the hash of the data model does not match a hash stored in the optimization data store: identifying a plurality of database engines for processing the data model; for each of the plurality of database engines, generating a different engine-level optimization based on a predicted volume of data to be used to process the call using the data model and based on type of the first entity, each different engine-level optimization indicating a change in process flow for a corresponding database engine; and processing the call using the data model by applying each different engine-level optimization to a corresponding database engine.

In Example 16, the subject matter of Example 15 comprises, wherein the generating comprises: sending a message to the first entity requesting a separate engine-level database optimization for each of the plurality of database engines requesting, the message comprising the hash.

In Example 17, the subject matter of Examples 15-16 comprises, wherein the processing the call comprises stitching each different engine-level database optimization to an information access query to be sent to the database.

In Example 18, the subject matter of Example 17 comprises, wherein the operations further comprise: determining whether a server level database optimization exists for the data model and prioritizing each different engine-level optimization over the server level database optimization if there are any conflicts.

In Example 19, the subject matter of Examples 15-18 comprises, wherein the database is an in-memory database.

In Example 20, the subject matter of Examples 15-19 comprises, wherein the generating comprises: passing the hash and an indication of the first entity to a machine learning model trained by a machine learning algorithm to generate different engine-level optimization based on a predicted volume of data to be used to process the call using the data model and based on type of the first entity.

Example 21 is at least one machine-readable medium comprising instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement any of Examples 1-20.

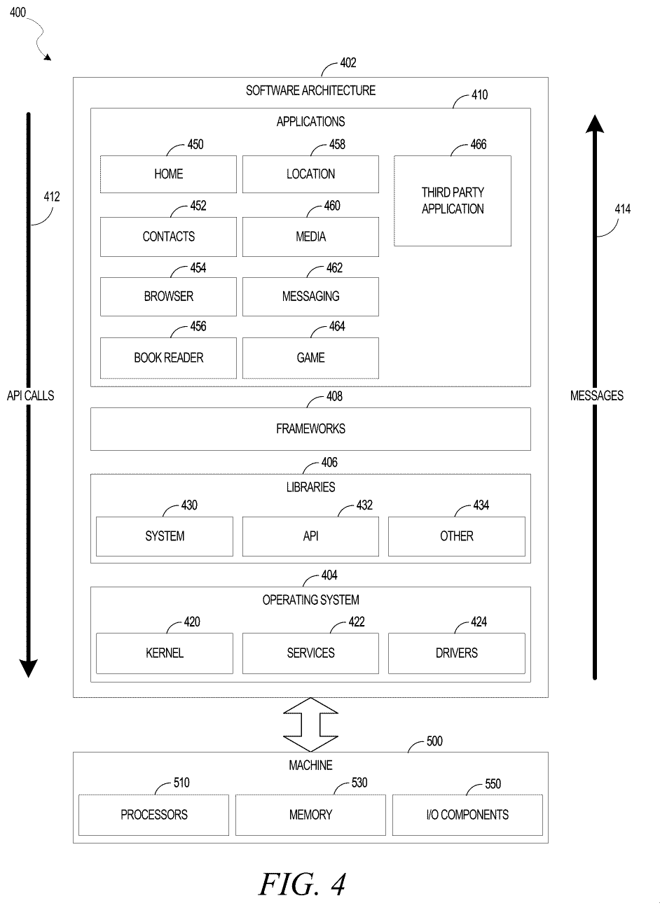

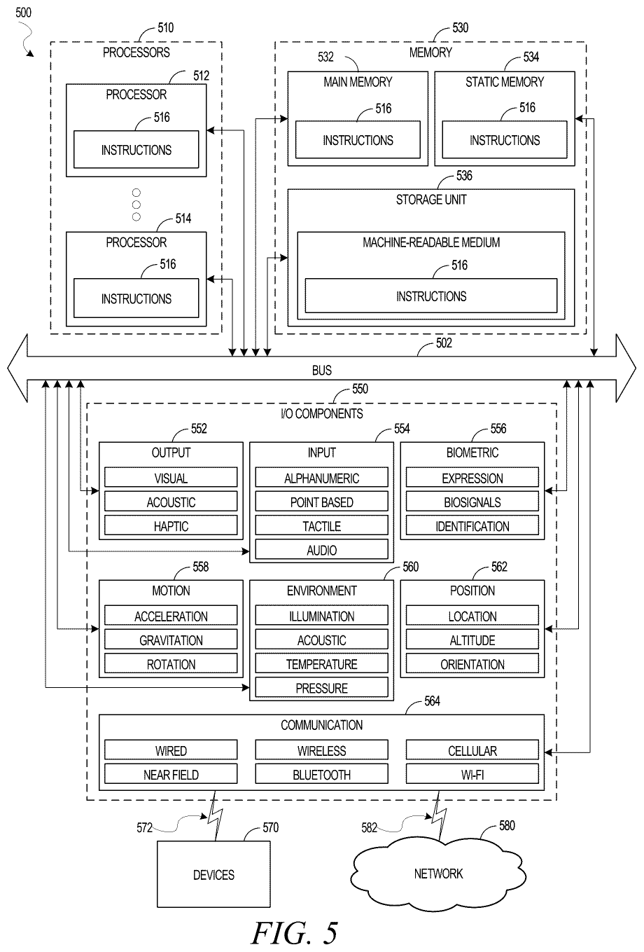

FIG. 4 is a block diagram 400 illustrating a software architecture 402, which can be installed on any one or more of the devices described above. FIG. 4 is merely a non-limiting example of a software architecture, and it will be appreciated that many other architectures can be implemented to facilitate the functionality described herein. In various embodiments, the software architecture 402 is implemented by hardware, such as a machine 500 of FIG. 5 that comprises processors 510, memory 530, and input/output (I/O) components 550. In this example architecture, the software architecture 402 can be conceptualized as a stack of layers where each layer may provide a particular functionality. For example, the software architecture 402 comprises layers such as an operating system 404, libraries 406, frameworks 408, and applications 410. Operationally, the applications 410 invoke API calls 412 through the software stack and receive messages 414 in response to the API calls 412, consistent with some embodiments.

In various implementations, the operating system 404 manages hardware resources and provides common services. The operating system 404 comprises, for example, a kernel 420, services 422, and drivers 424. The kernel 420 acts as an abstraction layer between the hardware and the other software layers, consistent with some embodiments. For example, the kernel 420 provides memory management, processor management (e.g., scheduling), component management, networking, and security settings, among other functionalities. The services 422 can provide other common services for the other software layers. The drivers 424 are responsible for controlling or interfacing with the underlying hardware. For instance, the drivers 424 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 406 provide a low-level common infrastructure utilized by the applications 410. The libraries 406 can include system libraries 430 (e.g., C standard library) that can provide functions such as memory allocation functions, string manipulation functions, mathematic functions, and the like. In addition, the libraries 406 can include API libraries 432 such as media libraries (e.g., libraries to support presentation and manipulation of various media formats such as Moving Picture Experts Group-4 [MPEG4], Advanced Video Coding [H.264 or AVC], Moving Picture Experts Group Layer-3 [MP3], Advanced Audio Coding [AAC], Adaptive Multi-Rate [AMR] audio codec, Joint Photographic Experts Group [PEG or JPG], or Portable Network Graphics [PNG], graphics libraries [e.g., an OpenGL framework used to render in two-dimensional (2D) and three-dimensional (3D) in a graphic context on a display], database libraries (e.g., SQLite to provide various relational database functions), web libraries [e.g., WebKit to provide web browsing functionality]), and the like. The libraries 406 can also include a wide variety of other libraries 434 to provide many other APIs to the applications 410.

The frameworks 408 provide a high-level common infrastructure that can be utilized by applications 410. For example, the frameworks 408 provide various graphical user interface functions, high-level resource management, high-level location services, and so forth. The frameworks 408 can provide a broad spectrum of other APIs that can be utilized by the applications 410, some of which may be specific to a particular operating system 404 or platform.

In an example embodiment, the applications 410 include a home application 450, a contacts application 452, a browser application 454, a book reader application 456, a location application 458, a media application 460, a messaging application 462, a game application 464, and a broad assortment of other applications, such as a third-party application 466. The applications 410 are programs that execute functions defined in the programs. Various programming languages can be employed to create one or more of the applications 410, structured in a variety of manners, such as object-oriented programming languages (e.g., Objective-C, Java, or C++) or procedural programming languages (e.g., C or assembly language). In a specific example, the third-party application 466 (e.g., an application developed using the ANDROID™ or IOS™ software development kit [SDK] by an entity other than the vendor of the particular platform) may be mobile software running on a mobile operating system such as IOS™, ANDROID™, WINDOWS® Phone, or another mobile operating system. In this example, the third-party application 466 can invoke the API calls 412 provided by the operating system 404 to facilitate functionality described herein.

FIG. 5 illustrates a diagrammatic representation of a machine 500 in the form of a computer system within which a set of instructions may be executed for causing the machine 500 to perform any one or more of the methodologies discussed herein. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. For example, the instructions 516 may cause the machine 500 to execute the method 300 of FIG. 3. Additionally, or alternatively, the instructions 516 may implement FIGS. 1-3 and so forth. The instructions 516 transform the general, non-programmed machine 500 into a particular machine 500 programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 516 to perform any one or more of the methodologies discussed herein.

The machine 500 may include processors 510, memory 530, and I/O components 550, which may be configured to communicate with each other such as via a bus 502. In an example embodiment, the processors 510 (e.g., a central processing unit [CPU], a reduced instruction set computing [RISC] processor, a complex instruction set computing [CISC] processor, a graphics processing unit [GPU], a digital signal processor [DSP], an application-specific integrated circuit [ASIC], a radio-frequency integrated circuit [RFIC], another processor, or any suitable combination thereof) may include, for example, a processor 512 and a processor 514 that may execute the instructions 516. The term “processor” is intended to include multi-core processors that may comprise two or more independent processors (sometimes referred to as “cores”) that may execute instructions 516 contemporaneously. Although FIG. 5 shows multiple processors 510, the machine 500 may include a single processor 512 with a single core, a single processor 512 with multiple cores (e.g., a multi-core processor 512), multiple processors 512, 514 with a single core, multiple processors 512, 514 with multiple cores, or any combination thereof.

The memory 530 may include a main memory 532, a static memory 534, and a storage unit 536, each accessible to the processors 510 such as via the bus 502. The main memory 532, the static memory 534, and the storage unit 536 store the instructions 516 embodying any one or more of the methodologies or functions described herein. The instructions 516 may also reside, completely or partially, within the main memory 532, within the static memory 534, within the storage unit 536, within at least one of the processors 510 (e.g., within the processor's cache memory), or any suitable combination thereof, during execution thereof by the machine 500.

The I/O components 550 may include a wide variety of components to receive input, provide output, produce output, transmit information, exchange information, capture measurements, and so on. The specific I/O components 550 that are included in a particular machine will depend on the type of machine. For example, portable machines such as mobile phones will likely include a touch input device or other such input mechanisms, while a headless server machine will likely not include such a touch input device. It will be appreciated that the I/O components 550 may include many other components that are not shown in FIG. 5. The I/O components 550 are grouped according to functionality merely for simplifying the following discussion, and the grouping is in no way limiting. In various example embodiments, the I/O components 550 may include output components 552 and input components 554. The output components 552 may include visual components (e.g., a display such as a plasma display panel [PDP], a light-emitting diode [LED] display, a liquid crystal display [LCD], a projector, or a cathode ray tube [CRT], acoustic components [e.g., speakers]), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 550 may include biometric components 556, motion components 558, environmental components 560, or position components 562, among a wide array of other components. For example, the biometric components 556 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 562 may include location sensor components (e.g., a Global Positioning System [GPS] receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 550 may include communication components 564 operable to couple the machine 500 to a network 580 or devices 570 via a coupling 582 and a coupling 572, respectively. For example, the communication components 564 may include a network interface component or another suitable device to interface with the network 580. In further examples, the communication components 564 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., coupled via a USB).

Moreover, the communication components 564 may detect identifiers or include components operable to detect identifiers. For example, the communication components 564 may include radio-frequency identification (RFID) tag reader components, NFC smart tag detection components, optical reader components (e.g., an optical sensor to detect one-dimensional bar codes such as Universal Product Code [UPC] bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 564, such as location via Internet Protocol (IP) geolocation, location via Wi-Fi® signal triangulation, location via detecting an NFC beacon signal that may indicate a particular location, and so forth.

The various memories (e.g., 530, 532, 534, and/or memory of the processor[s] 510) and/or the storage unit 536 may store one or more sets of instructions 516 and data structures (e.g., software) embodied or utilized by any one or more of the methodologies or functions described herein. These instructions (e.g., the instructions 516), when executed by the processor(s) 510, cause various operations to implement the disclosed embodiments.

As used herein, the terms “machine-storage medium,” “device-storage medium,” and “computer-storage medium” mean the same thing and may be used interchangeably. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, comprising memory internal or external to processors. Specific examples of machine-storage media, computer-storage media, and/or device-storage media include non-volatile memory, comprising by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 580 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 580 or a portion of the network 580, may include a wireless or cellular network, and the coupling 582 may be a Code Division Multiple Access (CDMA) connection, a Global System for Mobile communications (GSM) connection, or another type of cellular or wireless coupling. In this example, the coupling 582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) comprising 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 516 may be transmitted or received over the network 580 using a transmission medium via a network interface device (e.g., a network interface component included in the communication components 564) and utilizing any one of a number of well-known transfer protocols (e.g., Hypertext Transfer Protocol [HTTP]). Similarly, the instructions 516 may be transmitted or received using a transmission medium via the coupling 572 (e.g., a peer-to-peer coupling) to the devices 570. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 516 for execution by the machine 500, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
receiving a call to a database from a first entity;
identifying a data model to handle the call, the data model identifying a joining of data structures in the database;
using a hash function to generate a hash of the data model;
determining whether the hash of the data model matches a hash stored in an optimization data store;
in response to a determination that the hash of the data model does not match a hash stored in the optimization data store:
identifying a plurality of database engines for processing the data model;
for each of the plurality of database engines, generating a different engine-level optimization based on a predicted volume of data to be used to process the call using the data model and based on type of the first entity, each different engine-level optimization indicating a change in process flow for a corresponding database engine; and
processing the call using the data model by applying each different engine-level optimization to a corresponding database engine.

2. The system of claim 1, wherein the generating comprises:
sending a message to the first entity requesting a separate engine-level database optimization for each of the plurality of database engines requesting, the message including the hash.

3. The system of claim 1, wherein the processing the call includes stitching each different engine-level database optimization to an information access query to be sent to the database.

4. The system of claim 3, wherein the operations further comprise:
determining whether a server level database optimization exists for the data model and
prioritizing each different engine-level optimization over the server level database optimization if there are any conflicts.

5. The system of claim 1, wherein the database is an in-memory database.

6. The system of claim 1, wherein the generating comprises:
passing the hash and an indication of the first entity to a machine learning model trained by a machine learning algorithm to generate different engine-level optimization based on a predicted volume of data to be used to process the call using the data model and based on type of the first entity.

7. The system of claim 1, wherein in response to a determination that the hash of the data model matches a hash stored in the optimization data store:
retrieving one or more previously used engine-level database optimizations corresponding to the hash stored in the optimization data store; and
processing the call using the data model by applying each previously used different engine-level optimization to a corresponding database engine.

8. A method comprising:
receiving a call to a database from a first entity;
identifying a data model to handle the call, the data model identifying a join of data structures in the database;
using a hash function to generate a hash of the data model;
determining whether the hash of the data model matches a hash stored in an optimization data store;
in response to a determination that the hash of the data model does not match a hash stored in the optimization data store:
identifying a plurality of database engines for processing the data model;
for each of the plurality of database engines, generating a different engine-level optimization based on a predicted volume of data to be used to process the call using the data model and based on type of the first entity, each different engine-level optimization indicating a change in process flow for a corresponding database engine; and
processing the call using the data model by applying each different engine-level optimization to a corresponding database engine.

9. The method of claim 8, wherein the generating comprises:
sending a message to the first entity requesting a separate engine-level database optimization for each of the plurality of database engines requesting, the message including the hash.

10. The method of claim 8, wherein the processing the call includes stitching each different engine-level database optimization to an information access query to be sent to the database.

11. The method of claim 10, further comprising:
determining whether a server level database optimization exists for the data model and
prioritizing each different engine-level optimization over the server level database optimization if there are any conflicts.

12. The method of claim 8, wherein the database is an in-memory database.

13. The method of claim 8, wherein the generating comprises:
passing the hash and an indication of the first entity to a machine learning model trained by a machine learning algorithm to generate different engine-level optimization based on a predicted volume of data to be used to process the call using the data model and based on type of the first entity.

14. The method of claim 8, wherein in response to a determination that the hash of the data model matches a hash stored in the optimization data store:
retrieving one or more previously used engine-level database optimizations corresponding to the hash stored in the optimization data store; and
processing the call using the data model by applying each previously used different engine-level optimization to a corresponding database engine.

15. A non-transitory machine-readable medium storing instructions which, when executed by one or more processors, cause the one or more processors to perform operations comprising:
accessing historical time series data regarding workload of a first computer service;
receiving a call to a database from a first entity;
identifying a data model to handle the call, the data model identifying a joining of data structures in the database;
using a hash function to generate a hash of the data model;
determining whether the hash of the data model matches a hash stored in an optimization data store;
in response to a determination that the hash of the data model does not match a hash stored in the optimization data store:
identifying a plurality of database engines for processing the data model;
for each of the plurality of database engines, generating a different engine-level optimization based on a predicted volume of data to be used to process the call using the data model and based on type of the first entity, each different engine-level optimization indicating a change in process flow for a corresponding database engine; and
processing the call using the data model by applying each different engine-level optimization to a corresponding database engine.

16. The non-transitory machine-readable medium of claim 15, wherein the generating comprises:
sending a message to the first entity requesting a separate engine-level database optimization for each of the plurality of database engines requesting, the message including the hash.

17. The non-transitory machine-readable medium of claim 15, wherein the processing the call includes stitching each different engine-level database optimization to an information access query to be sent to the database.

18. The non-transitory machine-readable medium of claim 17, wherein the operations further comprise:
determining whether a server level database optimization exists for the data model and
prioritizing each different engine-level optimization over the server level database optimization if there are any conflicts.

19. The non-transitory machine-readable medium of claim 15, wherein the database is an in-memory database.

20. The non-transitory machine-readable medium of claim 15, wherein the generating comprises:
passing the hash and an indication of the first entity to a machine learning model trained by a machine learning algorithm to generate different engine-level optimization based on a predicted volume of data to be used to process the call using the data model and based on type of the first entity.
